(19) United States
(12) Patent Application Publication
(10) Pub. No.: US 2008/0148490 A1
(43) Pub. Date: Jun. 26, 2008

(54) COMPACT TOOL SET

(76) Inventor: Cheng-Ho Chen, Huatan Township (TW)

Correspondence Address: RABIN & BERDO, P.C;Suite 500, 1101 14th Street, N.W., Washington, DC, 20005, US

(21) Appl. No.: 11/613,387

(22) Filed: Dec. 20, 2006

(51) Int. Cl. B26B 11/00

(52) U.S. Cl. 7/118

(57) ABSTRACT

The present invention relates to a compact tool set which is hollow tube can jointed with a turning body for accommodating different hand tool component sets and a hemisphere screw nut for different functions on both sides respectively. Different components such as hand tool or components for first aid, mountain-climbing and camping could be assembled in the tube can, and different geometrical pattern concaves are set on the edge of the turning body. Suitable components and hemisphere screw nut can be pre-equipped for different occasions to procure the purpose that the carried tool set is applicable and the tool set can offer self-help effect in an emergency.

### BACKGROUND OF THE INVENTION

1. Field of the Invention

The present invention relates to a compact tool set; several components are assembled in one tube-shaped can, and moreover, one turning body and one hemisphere screw nut for different application are equipped on two sides of the tube can respectively. Hence, when emergency situation happened, the tool set can offer self-help effect to procure its applicable purpose.

2. Description of the Related Art

At present, components of most of the carry-on tool sets on market are fixed, and user just can use the equipped components. Fixed components carry-on tool set is made for user's easy application. However, after practical application, since the components are fixed and no free place for setting additional component, many sets of tool sets might be needed to be carried for different occasion or application. Though redundant components of some of the fixed components tool sets can be taken out, space would still be occupied and spare components might not be applied suitably and become a waste.

### SUMMARY OF THE INVENTION

The objective of the present invention is to provide a compact tool set; several components are assembled in one tube-shaped can, and moreover, one turning body and one hemisphere screw nut for different application are equipped on two sides of the tube can respectively. Hence, when emergency situation happened, the tool set can offer self-help effect and procure its applicable purpose.

The second objective of the present invention is to provide a compact tool set in which different hand tools and components for first aid, mountain-climbing and camping are equipped for applying on different occasions.

The third objective of the present invention is to provide a compact tool set on which hemisphere screw nut for different applications can be equipped on the side of tube can for procuring its applicable purpose.

The fourth objective of the present invention is to provide a compact tool set on which a turning body which is equipped on the side of tube can has different geometrical pattern concaves for linking up the components stored in the tube can to procure its applicable purpose.

### BRIEF DESCRIPTION OF THE DRAWINGS

Other features and advantages of the present invention will become apparent in the following detailed description of the preferred embodiments, with reference to the accompanying drawings, in which:

FIG. 1 is a structure decomposition relief exploded view of the present invention.

FIG. 2-A is a schematic view of a portion of components in tube can of the present invention.

FIG. 2-B is a schematic view of a portion of components in tube can of the present invention.

FIG. 2-C is a schematic view of a portion of components in tube can of the present invention.

FIG. 3-A is a schematic view of different component in tube can of the present invention.

FIG. 3-B is a schematic view of different component in tube can of the present invention.

FIG. 4-A is a schematic view of different component collocated with the present invention.

FIG. 4-B is a schematic view of different component collocated with the present invention.

FIG. 4-C is a schematic view of different component collocated with the present invention.

FIG. 4-D is a schematic view of different component collocated with the present invention.

FIG. 4-E is a schematic view of different component collocated with the present invention.

FIG. 5-A is a schematic view of different length of the tube can of the present invention.

FIG. 5-B is a schematic view of different length of the tube can of the present invention.

FIG. 5-C is a schematic view of different length of the tube can of the present invention.

FIG. 6-A is a schematic view of the preferred embodiment of the present invention.

FIG. 6-B is a schematic view of the preferred embodiment of the present invention.

FIG. 6-C is a schematic view of the preferred embodiment of the present invention.

### DETAILED DESCRIPTION OF THE PREFERRED EMBODIMENTS

In the detailed description of the preferred embodiments, it should be noted that like elements are indicated by the same reference numerals throughout the disclosure.

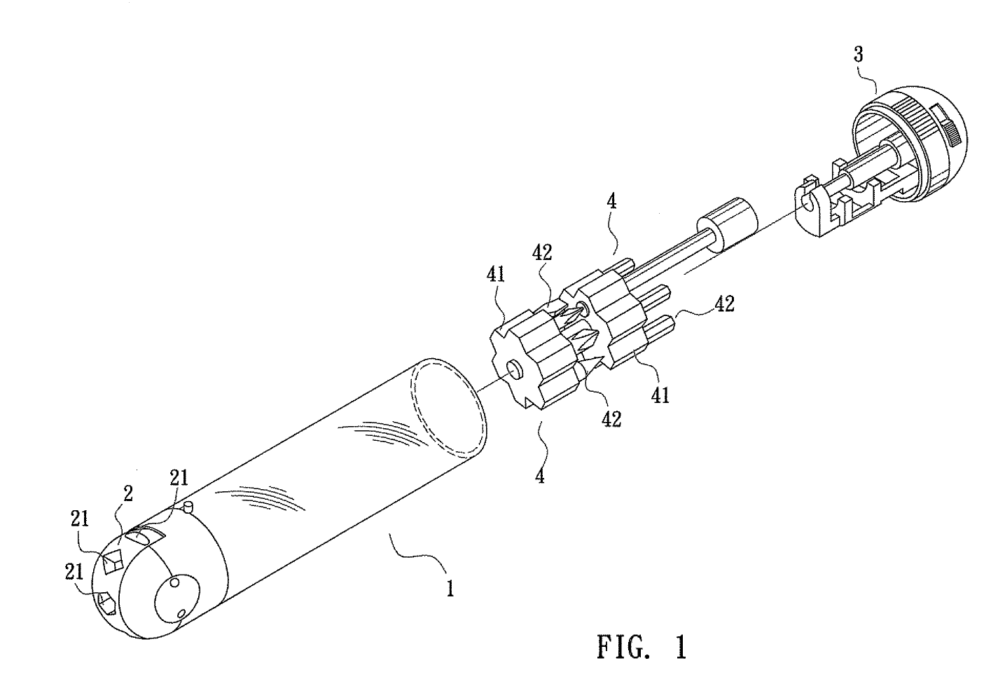

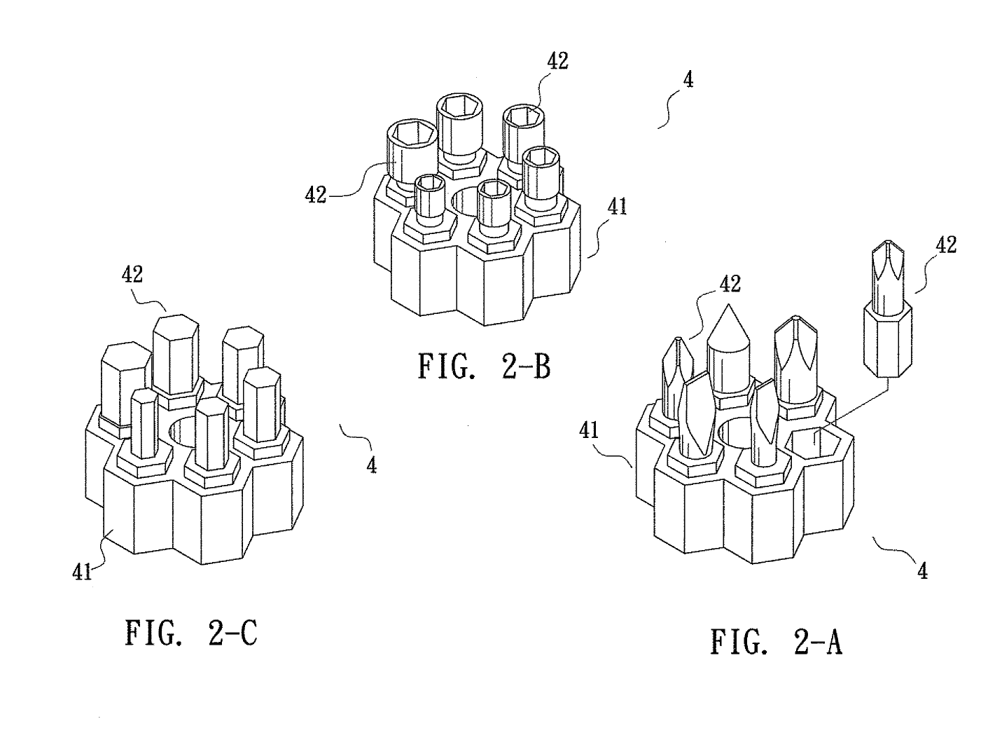

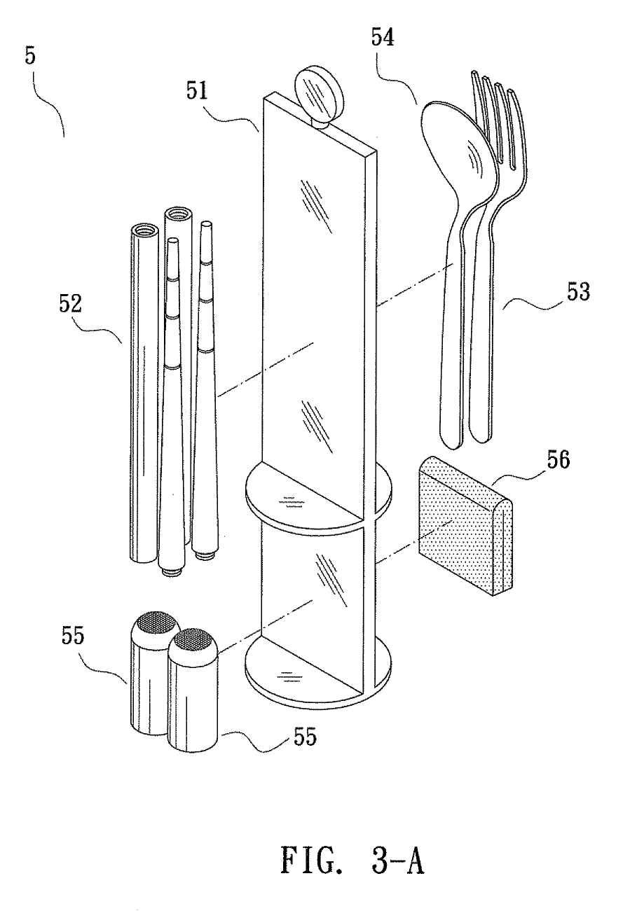

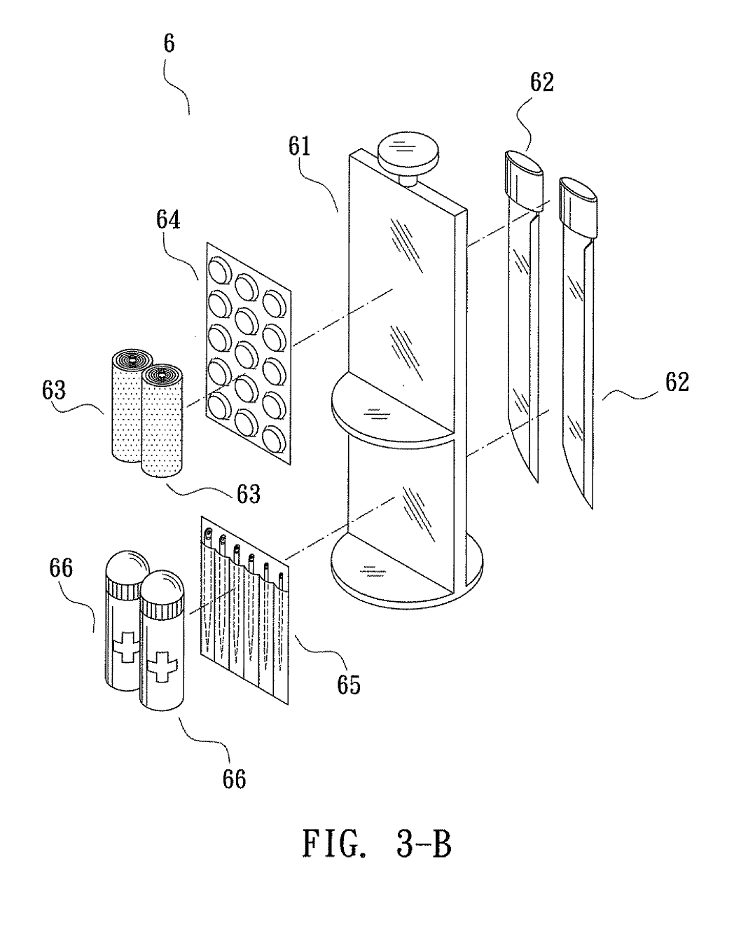

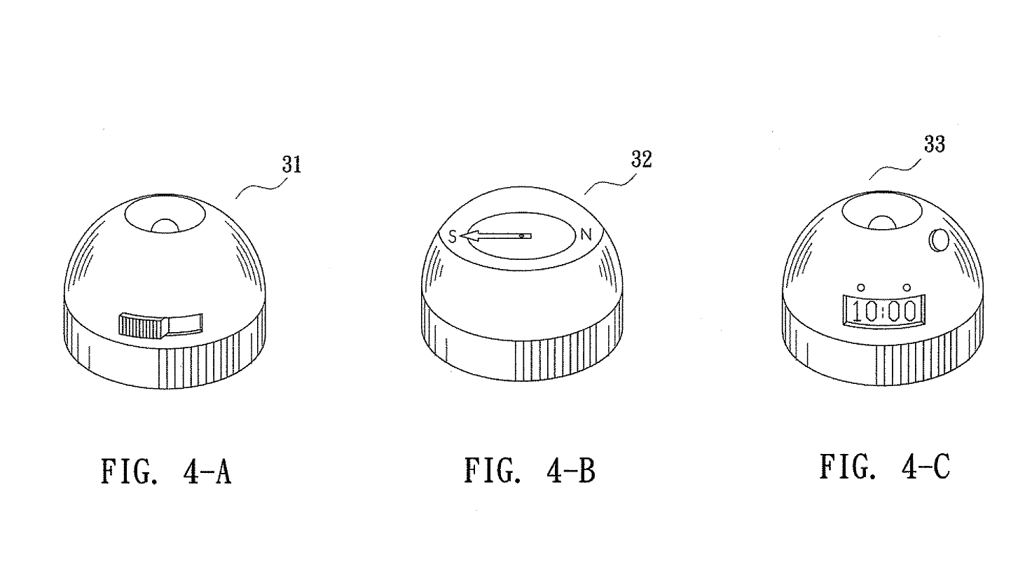

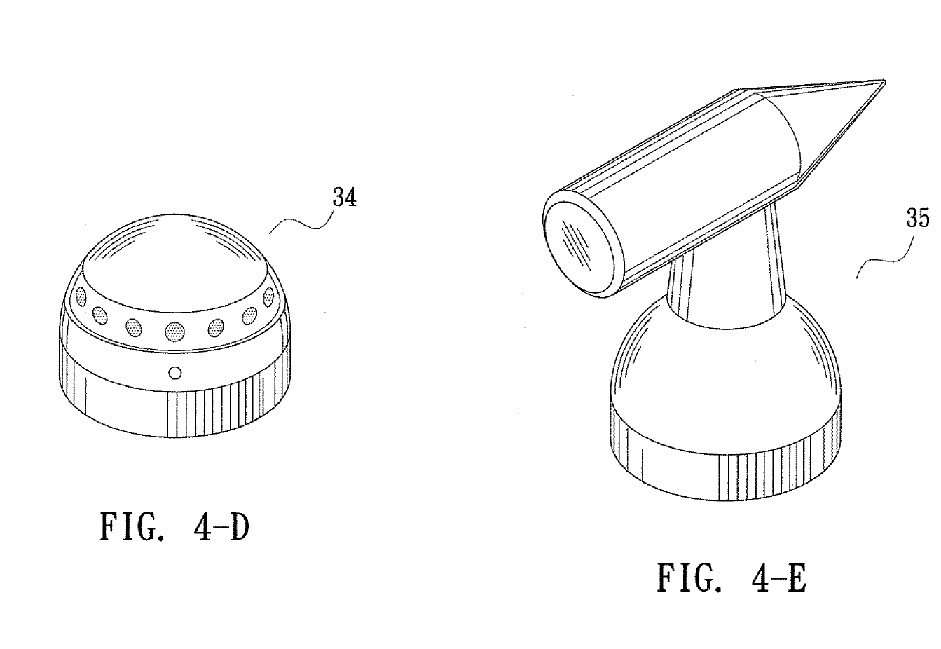

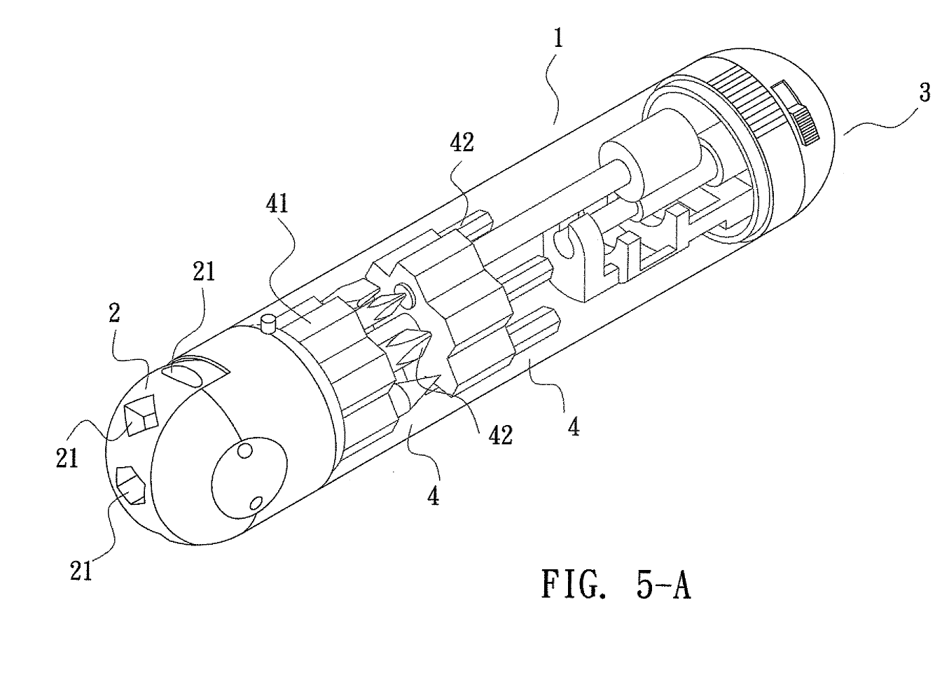

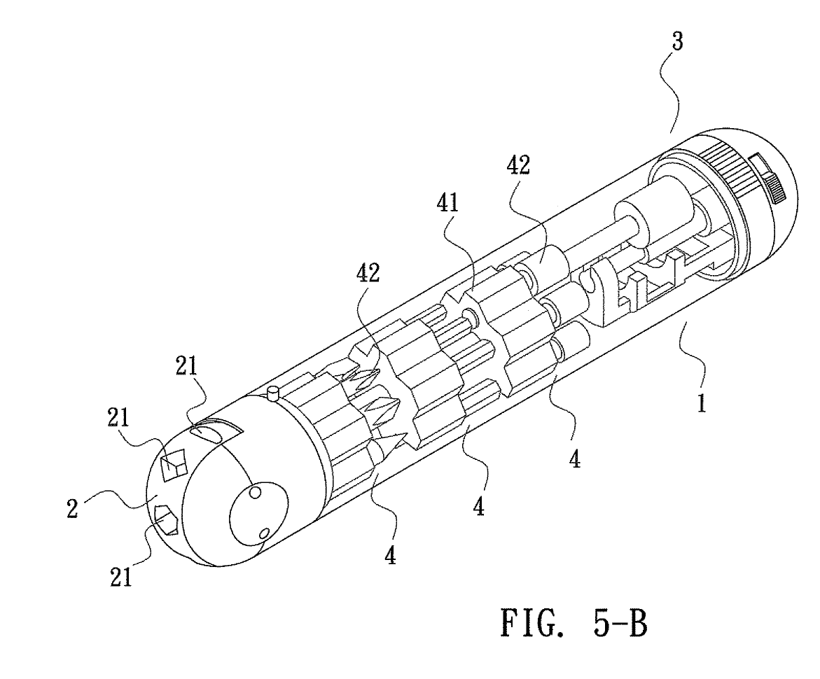

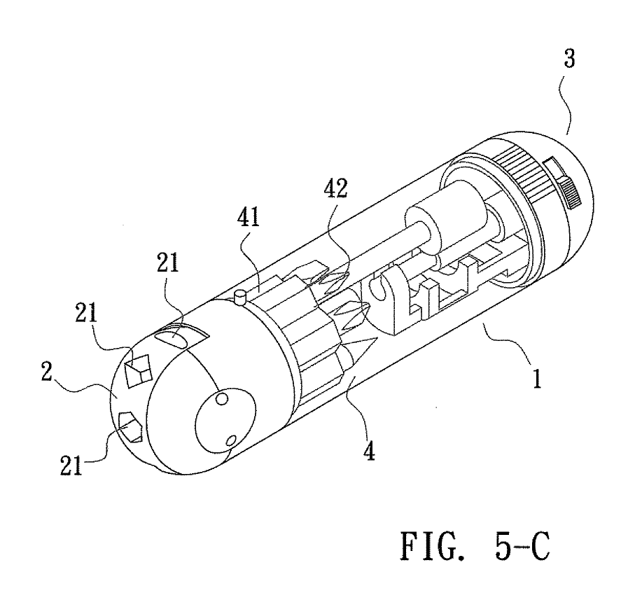

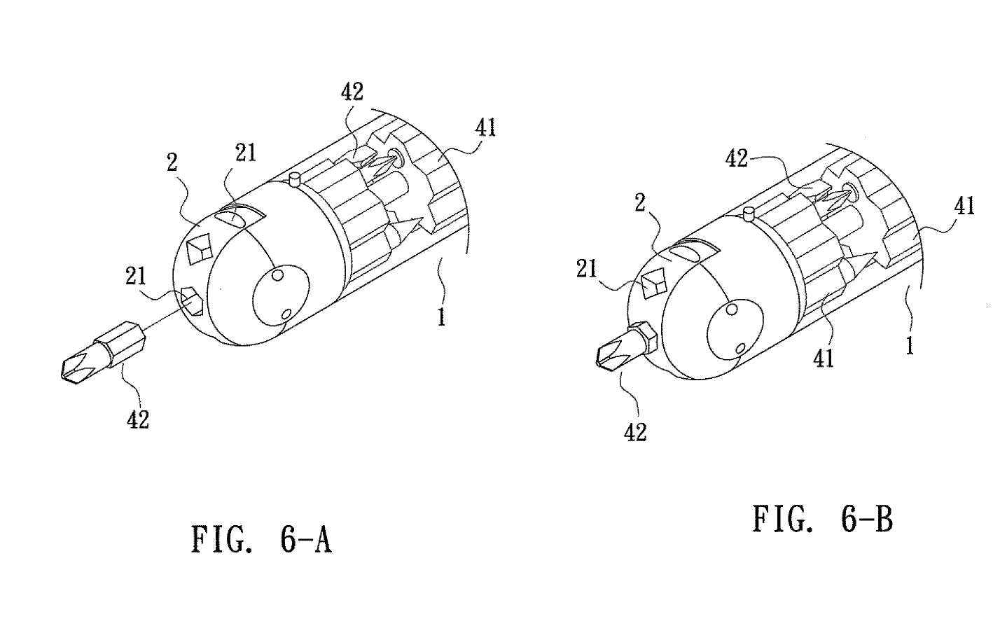

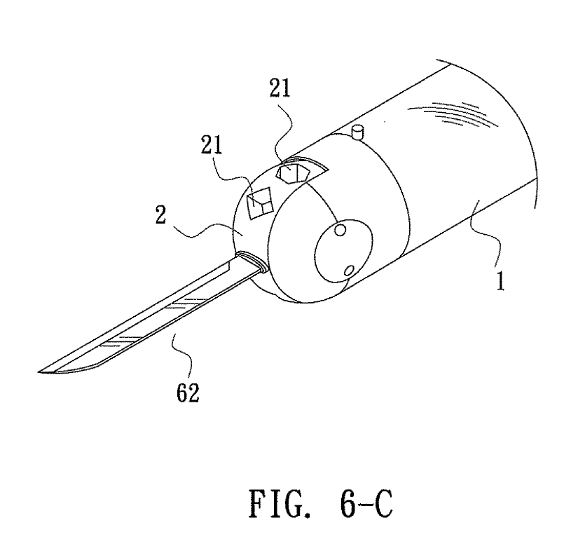

Please refer to FIG. 1. The basic components of the compact tool set of the invention are one tube can 1, one turning body 2 and one hemisphere screw nut 3, and turning body 2 and hemisphere screw nut 3 are linked up on two sides of tube can 1 respectively. Different components can be stored in tube can 1. As for hand tool 4 for motorbike or bike (as FIG. 2A, B, C), base 41 can accommodate different types of accessories 42; mountain-climbing or camping components 5 (as FIG. 3-A) accommodate chopsticks 52, fork 53, spoon 54, cruet 55, wiper 56, tool scissors, saw, nutriment, food, call-for-help marker, match, lens and cotton rope, etc. via plate 51, or first aid components 6 make use of plate 61 to accommodate cutting tool 62, bandage 63, pain-killer 64, operation blade 65 and disinfection drugs 66, etc. Furthermore, different geometrical pattern concaves 21, for linking up accessory 42 of hand tool 4 stored in tube can 1 (as FIG. 6A, B) or jointing with other accessories (as FIG. 6C), are set on the edge of turning body 2 located on one side of the tube can 1. Hemisphere screw nut set 3 assembled on one side of the tube can 1 is designed for different application, such as lighting hemisphere screw nut 31 (as FIG. 4A), direction pointer hemisphere screw nut 32 (as FIG. 4B), clock hemisphere screw nut 33 (as FIG. 4C), flashing light hemisphere screw nut 34 (as FIG. 4D), raping hemisphere screw nut 35 (as FIG. 4E), etc. Moreover, tube can 1 has different length (as FIG. 5A, B, C) for enlarging or diminishing space in the tube can to make it more applicable.

User can prepare suitable components (can be mixed) in tube can 1 and screw up suitable hemisphere screw nut set 3 for different occasions. Hence, at any occasion, the carried tool set can be applicable and procure self-help effect.

While the present invention has been described in connection with what is considered the most practical and preferred embodiments, it is understood that the present invention is not limited to the disclosed embodiments but is intended to cover various arrangements included within the spirit and scope of the broadest interpretations and equivalent arrangements.

What is claimed is:

1. The present invention relates to a compact tool set; different components are assembled in one tube-shaped can, and moreover, one turning body and one hemisphere screw nut for different application are equipped on two sides of the tube can respectively; hence, when emergency situation happened, the tool set can offer self-help effect to procure the purpose that the carried tool set is applicable.

2. A compact tool set as claimed in claim 1, wherein said different hand tools and components for first aid, mountain-climbing and camping can be pre-equipped suitably for different occasions to procure the purpose that the carried tool set is applicable.

3. A compact tool set as claimed in claim 1, wherein said a hemisphere screw nut for different applications can be equipped on the side of the tube can for procuring the purpose that the carried tool set is applicable.

4. A compact tool set as claimed in claim 1, wherein said different geometrical pattern concaves are set on the edge of the turning body for linking up the components stored in the tube can to procure the purpose that the carried tool set is applicable.
